(19) United States
(12) Patent Application Publication
(10) Pub. No.: US 2026/0024961 A1
(43) Pub. Date: Jan. 22, 2026

(54) ROUTING BOARD AND ELECTRICAL CONNECTION UNIT

(71) Applicant: YAZAKI CORPORATION, Tokyo (JP)

(72) Inventors: Ryu Senoo, Kakegawa-shi (JP); Hirotaka Mukasa, Kakegawa-shi (JP); Kazuhiko Tsuchiya, Kakegawa-shi (JP)

(21) Appl. No.: 19/239,870

(22) Filed: Jun. 16, 2025

(30) Foreign Application Priority Data
Jul. 16, 2024 (JP) 2024-113237

(51) Int. Cl. H02B 1/20; H02B 1/04; H02G 5/02

(52) U.S. Cl. CPC H02B 1/20; H02B 1/042; H02G 5/02

(57) ABSTRACT

A routing board includes a base member having an insulating base portion, a first bus bar that is held by the insulating base portion and includes a routing portion routed from a first part to a second part of the insulating base portion, and a second bus bar held by the first part, in which a part of the first bus bar passes through a region overlapping the second bus bar when viewed from a thickness direction of the insulating base portion, at least a part of the first bus bar extends in a plate shape along the insulating base portion, and at least a part of the second bus bar extends in a plate shape along the insulating base portion.

### BACKGROUND OF THE INVENTION

### Field of the Invention

The present disclosure relates to a routing board and an electrical connection unit.

Priority is claimed on Japanese Patent Application No. 2024-113237 filed in Japan on Jul. 16, 2024, the content of which is incorporated herein by reference.

### Description of the Related Art

An electrical connection unit having a housing that accommodates electronic components and a bus bar attached to the housing in a standing posture is known.

### CITATION LIST

### Patent Document

Patent Document 1: Japanese Unexamined Patent Application, First Publication No. 2024-037492

### SUMMARY OF THE INVENTION

Incidentally, a height of an electrical connection unit is expected to be further reduced.

An embodiment provides a routing board and an electrical connection unit capable of reducing the height.

A routing board of an embodiment includes a base member having an insulating base portion; a first bus bar that is held by the insulating base portion and includes a routing portion routed from a first part to a second part of the insulating base portion; and a second bus bar held by the first part, in which a part of the first bus bar passes through a region overlapping the second bus bar when viewed from a thickness direction of the insulating base portion, at least a part of the first bus bar extends in a plate shape along the insulating base portion, and at least a part of the second bus bar extends in a plate shape along the insulating base portion.

According to one embodiment, a height of an electrical connection unit can be reduced.

### BRIEF DESCRIPTION OF THE DRAWINGS

FIG. 1 is a perspective view illustrating a routing board according to an embodiment.

FIG. 2 is a perspective view for describing an electronic component and a connection component according to the embodiment.

FIG. 3 is a perspective view for describing the electronic component and the connection component according to the embodiment.

FIG. 4 is a perspective view illustrating the connection component according to the embodiment.

FIG. 5 is a cross-sectional view taken along line A-A of the structure illustrated in FIG. 1.

FIG. 6 is a cross-sectional view taken along line B-B of the structure illustrated in FIG. 1.

FIG. 7 is a cross-sectional view taken along line C-C of the structure illustrated in FIG. 1.

FIG. 8 is a cross-sectional view taken along line D-D of the structure illustrated in FIG. 1.

FIG. 9 is a plan view illustrating the routing board according to the embodiment.

FIG. 10 is a cross-sectional view illustrating a modification example of the embodiment.

FIG. 11 is a perspective view illustrating a modification example of the embodiment.

FIG. 12 is a partially exploded perspective view of a first bus bar according to a modification example of the embodiment.

### DETAILED DESCRIPTION OF THE INVENTION

Hereinafter, embodiments will be described with reference to the drawings. In the following description, constitutions having the same or similar functions are denoted by the same reference numbers. Redundant descriptions of these constitutions may be omitted. Note that the specific constitution described below does not limit an applicable scope of the embodiment.

In the present disclosure, the terms are defined as follows. The term “connection” is not limited to a mechanical connection, and may include an electrical connection. That is, the term “connection” is not limited to a case where two elements that are connection targets are directly connected, and may include a case where two elements that are connection targets are connected with another element interposed therebetween. The term “facing” indicates that virtual projection images of two target objects overlap each other when viewed from a specific direction. That is, the term “facing” is not limited to a case where two target objects directly face each other, and may include a case where two target objects face each other in a state in which another member exists between the two target objects. “Parallel”, “orthogonal”, or “the same” may include “substantially parallel”, “substantially orthogonal”, or “substantially the same”, respectively.

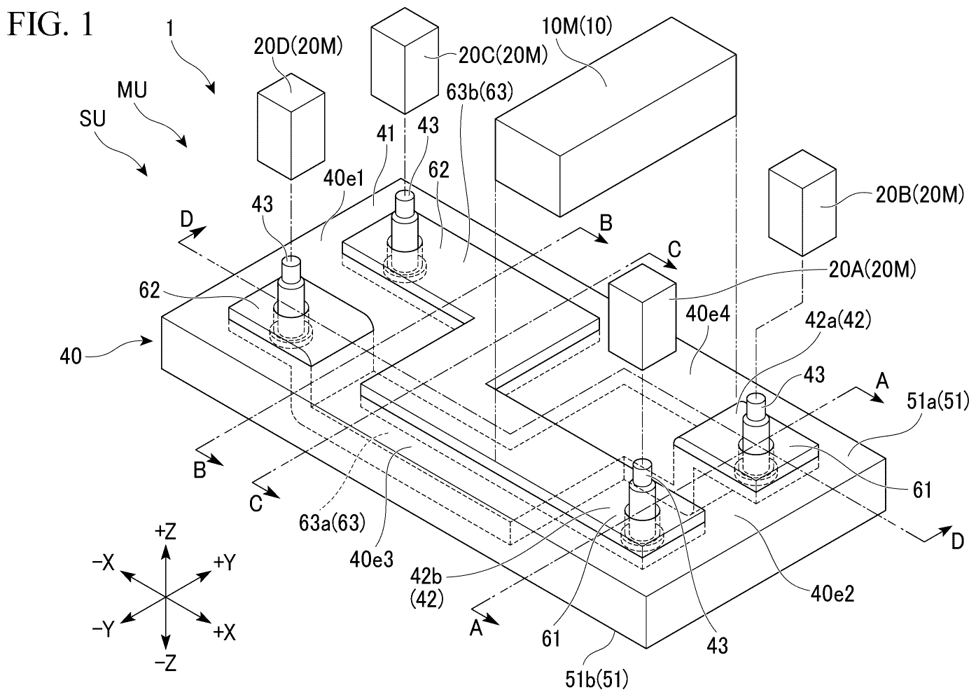

In the present disclosure, a +X direction, a −X direction, a +Y direction, a −Y direction, a +Z direction, and a −Z direction are defined as follows. The +X direction is a direction from a first end 40e1 to a second end 40e2 of a routing board that will be described later (see FIG. 1). The −X direction is a direction opposite to the +X direction. Hereinafter, in a case where the +X direction and the −X direction are not distinguished, the directions will be simply referred to as “X direction”. The +Y direction and the −Y direction are directions intersecting (for example, orthogonal to) the X direction. The +Y direction is a direction from a third end 40e3 to a fourth end 40e4 of the routing board that will be described later (see FIG. 1). The −Y direction is a direction opposite to the +Y direction. Hereinafter, in a case where the +Y direction and the −Y direction are not distinguished, the directions will be simply referred to as “Y direction”. The +Z direction and the −Z direction are directions intersecting (for example, orthogonal to) the X direction and the Y direction. The +Z direction is a thickness direction of an insulating base portion of a base member included in the routing board (see FIG. 1). The −Z direction is a direction opposite to the +Z direction. Hereinafter, in a case where the +Z direction and the −Z direction are not distinguished, the directions will be simply referred to as “Z direction”. The Z direction is an example of a “first direction”. The X direction is an example of a “second direction”. The Y direction is an example of a “third direction”. The “second direction” is not limited to the X direction, and may be the Y direction or other directions. The “third direction” is not limited to the Y direction, and is a direction intersecting the “first direction” and the “second direction”.

Hereinafter, in a case where the X direction and the Y direction are not distinguished, the directions may be referred to as “horizontal direction”. Hereinafter, the Z direction may be referred to as “vertical direction”. Hereinafter, the +Z direction side may be referred to as “upper”, and the −Z direction side may be referred to as “lower”. However, these expressions are expressions for convenience of description, and do not limit a gravity direction of an electrical connection unit 1 (an installation posture of the electrical connection unit 1).

### First Embodiment

### <1. Constitution of Electrical Connection Unit>

FIG. 1 is a cross-sectional view illustrating an electrical connection unit 1 of a first embodiment. The electrical connection unit 1 is, for example, an in-vehicle device mounted on a vehicle such as an electric vehicle (EV), a hybrid electric vehicle (HEV), or a plug-in hybrid electric vehicle (PHEV).

The electrical connection unit 1 includes, for example, a main body MU. In addition, the electrical connection unit 1 may include an outer member that covers a subunit SU included in the main body MU. The outer member is a member for securing a rigidity of the electrical connection unit 1 and enhancing a heat dissipation property of the electrical connection unit 1. The outer frame member is made of a metal (for example, aluminum or an aluminum alloy).

### <2. Main Body>

First, the main body MU will be described.

FIG. 1 is a perspective view for describing the main body MU. The main body MU is a portion that performs a main function (for example, switching of electrical connection states or overcurrent protection) of the electrical connection unit 1. In the present embodiment, the main body MU includes one subunit SU. Furthermore, the main body MU may include a plurality of subunits SU. In this case, each subunit SU has the same or similar basic structure. When the plurality of subunits SU are coupled, the main body MU can exert a function of each subunit SU. Each subunit SU may be referred to as a “circuit constitution body”.

The subunit SU has an electrical function. The subunit SU includes, for example, at least one or more electronic components 10, at least one or more connection components 20, at least one or more connection components 30, and a routing board 40. The electronic component 10 is electrically connected to the routing board 40. The connection components 20 and 30 are members forming an energization path in the vertical direction. The connection components 20 and 30 may be referred to as “vertical routing members”.

### <3. Electronic Component and Connection Component for Component Connection>

First, the electronic component 10 and the connection component 20 for component connection will be described.

The electronic component 10 is an electronic component mounted according to a function required for the subunit SU. The electronic component 10 is, for example, a connector, a fuse, a relay (for example, a mechanical relay or a semiconductor relay), a capacitor, a branch component, any of various sensors (for example, a current sensor or a voltage sensor), an electronic control unit, or an electronic component unit in which two or more of these are unitized. Note that the type of the electronic component 10 is not limited to the above example. The electronic component 10 is, for example, a heat generating component that generates heat at the time of energization. Hereinafter, a first-type electronic component 10M and a second-type electronic component 10N will be described as examples of the electronic component 10.

The connection component 20 is a component that electrically connects the electronic component 10 to the routing board 40. The connection component 20 forms part of an energization path in the subunit SU. The connection component 20 is made of a metal (for example, copper or a copper alloy). The connection component 20 may be referred to as a “metal component”. Hereinafter, a first-type connection component 20M and a second-type connection component 20N will be described as examples of the connection component 20.

### <3.1 First-Type Electronic Component>

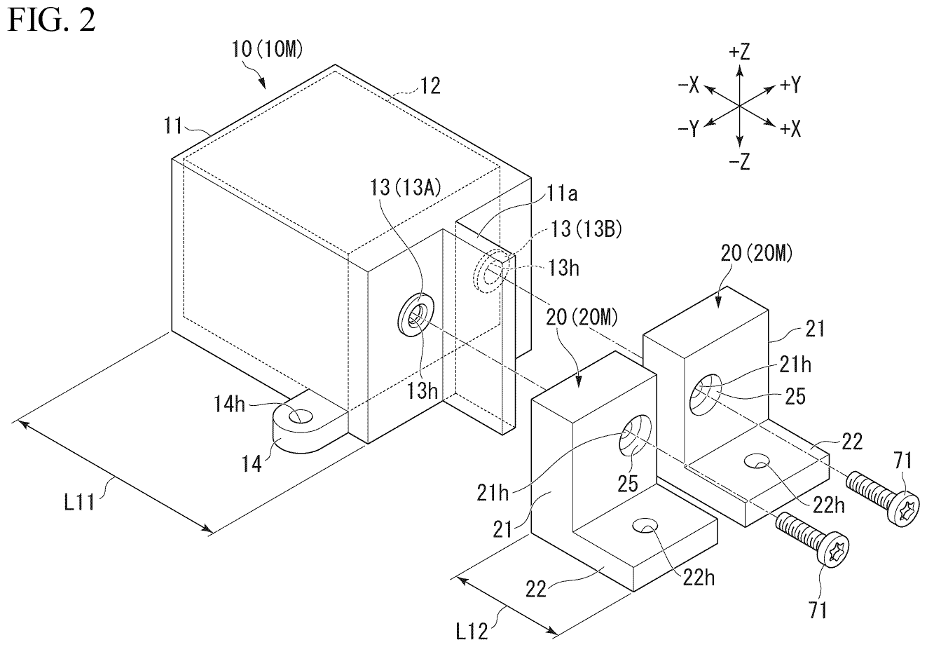

FIG. 2 is a perspective view illustrating the first-type electronic component 10M and the first-type connection component 20M. The first-type electronic component 10M is an electronic component in which a plurality of terminals 13 are disposed to be arranged at one end of the electronic component 10M. The electronic component 10M includes, for example, a case 11, a component body 12, a plurality of terminals 13, and a plurality of attachment portions 14.

### (Case)

The case 11 is an outer member that forms most of the outer shape of the electronic component 10M. The case 11 is made of, for example, synthetic resin and has an insulating property. The case 11 accommodates the component body 12. The case 11 and the component body 12 may be integrally formed.

In the present embodiment, the case 11 has an insulating rib 11a that protrudes in the horizontal direction (for example, the X direction) and extends in the Z direction. The insulating rib 11a has, for example, a plate shape formed in the horizontal direction (for example, the X direction) and the Z direction. The insulating rib 11a extends over the entire length of the case 11 in the Z direction, for example. The insulating rib 11a is disposed between the plurality of terminals 13 (a terminal 13A and a terminal 13B that will be described later). The insulating rib 11a electrically insulates the terminal 13A from the terminal 13B. In the present embodiment, part of the insulating rib 11a is disposed between first portions 21 (that will be described later) of two connection components 20M connected to the electronic component 10M. The insulating rib 11a electrically insulates the first portions 21 of the two connection components 20M connected to the electronic component 10M from each other.

### (Component Body)

The component body 12 is a portion that performs a main function of the electronic component 10M. For example, in a case where the electronic component 10M is a relay, the component body 12 includes a switch (for example, a contact) that switches between a conductive state and a non-conductive state. For example, in a case where the electronic component 10M is a fuse, the component body 12 includes a fusion portion that is fused when an overcurrent flows. For example, in a case where the electronic component 10M is a capacitor, the component body 12 includes a portion that stores electric charge.

### (Terminal)

The terminal 13 is an electrical connection portion exposed to the outside of the case 11. The terminal 13 is electrically connected to the component body 12 inside the case 11. In the present embodiment, the electronic component 10M includes a terminal 13A and a terminal 13B as the plurality of terminals 13. One of the terminal 13A and the terminal 13B is a terminal on the positive electrode side. The other of the terminal 13A and the terminal 13B is a terminal on the negative electrode side. One of the terminal 13A and the terminal 13B is an example of a “first terminal”. The other of the terminal 13A and the terminal 13B is an example of a “second terminal”.

In the present embodiment, the terminal 13A and the terminal 13B are provided at one end of the electronic component 10M in the horizontal direction (for example, the X direction). The terminal 13A and the terminal 13B are disposed to be arranged in the horizontal direction (for example, the Y direction). Each terminal 13 has an attachment hole 13h to which a fastening member 71 (for example, a screw or a bolt) that will be described later is attached. The attachment hole 13h is open in the horizontal direction (for example, the X direction). An inner circumferential surface of the attachment hole 13h of the electronic component 10M has a screw groove.

### (Attachment Portion)

The attachment portion 14 is a portion for fixing the electronic component 10M when a protrusion or a through-hole corresponding to the attachment hole 14h is present in the routing board 40. For example, the attachment portion 14 has an attachment hole 14h to which a fastening member (for example, a screw or a bolt) is attached. The attachment hole 14h is open in the Z direction. The attachment hole 14h is an insertion hole through which a fastening member or a protrusion passes.

### <3.2 First-Type Connection Component>

The first-type connection component 20M is a component that electrically connects the first-type electronic component 10M to the routing board 40. In the present embodiment, the connection component 20M electrically connects the electronic component 10M to the bus bar 42 included in the routing board 40. In the present embodiment, a width L12 of the connection component 20M in a longitudinal direction (for example, the X direction) of the electronic component 10M is smaller than a width L11 of the electronic component 10M in the longitudinal direction. The connection component 20M includes, for example, a first portion 21 and a second portion 22.

### (First Portion)

The first portion 21 of the connection component 20M is a portion connected to the terminal 13 of the electronic component 10M. The first portion 21 is a plate-shaped or rectangular parallelepiped portion extending in the Z direction. The first portion 21 extends in the Z direction along one end (for example, an end in the X direction) of the electronic component 10M. The first portion 21 is a standing portion that stands in the Z direction with respect to the routing board 40 (for example, with respect to a bus bar 42 that will be described later). The first portion 21 is adjacent to the electronic component 10M in the horizontal direction (for example, the X direction). For example, the first portion 21 is adjacent to the terminal 13 of the electronic component 10M in the horizontal direction (for example, the X direction), and is connected to the terminal 13 of the electronic component 10M from the horizontal direction (for example, the X direction).

The first portion 21 of the connection component 20M has a first attachment hole 21h through which the fastening member 71 (for example, a screw or a bolt) passes. The first attachment hole 21h is open in the horizontal direction (for example, the X direction). The first portion 21 has a recess 25 around the first attachment hole 21h. The recess 25 is an accommodation portion that accommodates a head of the fastening member 71 inserted into the first attachment hole 21h. The fastening member 71 that has passed through the first attachment hole 21h is engaged with the attachment hole 13h of the terminal 13 of the electronic component 10M, and thus the first portion 21 is physically and electrically connected to the terminal 13 of the electronic component 10M. The first portion 21 need not have the recess 25.

### (Second Portion)

The second portion 22 of the connection component 20M is a portion connected to the bus bar 42. The second portion 22 protrudes in the horizontal direction (for example, the X direction) from end of the first portion 21 on the −Z direction side. The second portion 22 is a plate portion provided in the horizontal direction. The second portion 22 is adjacent to the bus bar 42 in the Z direction, and is connected to the bus bar 42 from the Z direction. The second portion 22 of the connection component 20M is attached from the Z direction to the fastening member 43 (for example, a screw or a bolt) protruding from the bus bar 42 in the +Z direction, and is physically and electrically connected to the bus bar 42. In the present embodiment, the second portion 22 of the connection component 20M has a second attachment hole 22h through which the fastening member 43 passes. The second attachment hole 22h is open in the Z direction. In the second portion 22, the fastening member 43 passes through the second attachment hole 22h. A fastening element such as a nut is engaged with the tip of the fastening member 43 that has passed through the second attachment hole 22h, and thus the second portion 22 is fixed to the bus bar 42. In the present embodiment, the first portion 21 and the second portion 22 form one L-shaped connection component 20M.

### <3.3 Second-Type Electronic Component>

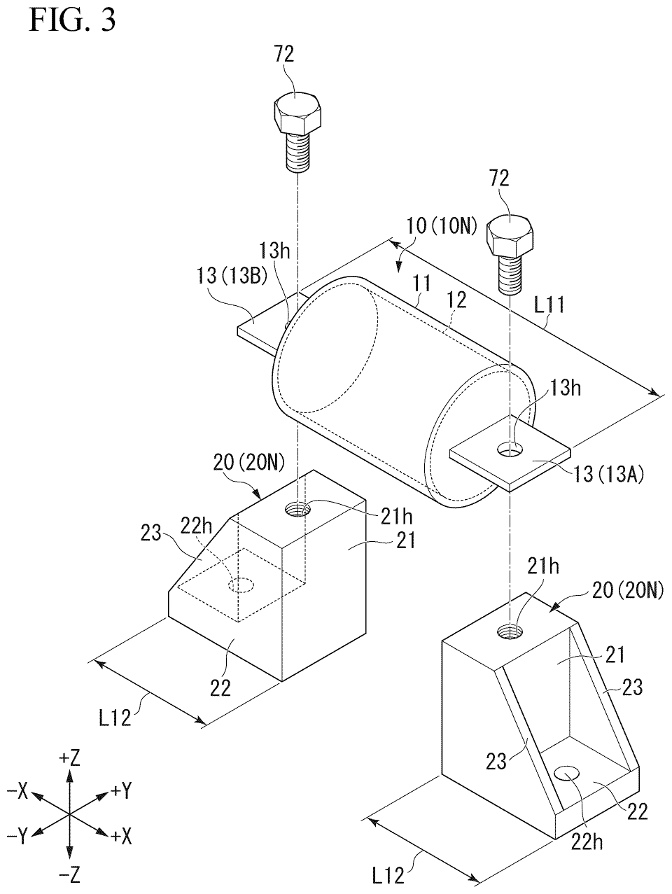

FIG. 3 is a perspective view illustrating the second-type electronic component 10N and the second-type connection component 20N. The second-type electronic component 10N is an electronic component in which two terminals 13 are separately disposed at both ends in the horizontal direction of the electronic component 10N. The electronic component 10N includes, for example, a case 11, a component body 12, and a plurality of terminals 13. Note that, among the constitutions of the electronic component 10N, constitutions having functions similar to those of the electronic component 10M are denoted by the same reference numbers. In this case, in the description regarding the electronic component 10N, the “electronic component 10M” may be replaced with the “electronic component 10N” in the description regarding the electronic component 10M described above.

In the electronic component 10N, the terminal 13A and the terminal 13B are disposed separately at both ends of the electronic component 10N in the horizontal direction (for example, the X direction). Each terminal 13 has an attachment hole 13h to which a fastening member 72 (for example, a screw or a bolt) that will be described later is attached. The attachment hole 13h is open in the Z direction. For example, the attachment hole 13h of the electronic component 10N is an insertion hole through which the fastening member 72 passes. One of the terminal 13A and the terminal 13B is an example of a “first terminal”. The other of the terminal 13A and the terminal 13B is an example of a “second terminal”.

### <3.4 Second-Type Connection Component>

The second-type connection component 20N is a component that electrically connects the second-type electronic component 10N to the routing board 40. For example, the connection component 20N electrically connects the electronic component 10N to the bus bar 42 included in the routing board 40. In the present embodiment, a width L12 of the connection component 20N in the longitudinal direction (for example, the X direction) of the electronic component 10N is smaller than a width L11 of the electronic component 10N in the longitudinal direction. The connection component 20N includes, for example, a first portion 21, a second portion 22, and a third portion 23.

### (First Portion)

The first portion 21 of the connection component 20N is a portion connected to the terminal 13 of the electronic component 10N. The first portion 21 is a rectangular parallelepiped portion extending in the Z direction. The first portion 21 is a standing portion that stands in the Z direction with respect to the routing board 40 (for example, with respect to the bus bar 42). The first portion 21 is adjacent to the terminal 13 of the electronic component 10N in the Z direction, and is connected to the terminal 13 of the electronic component 10N from the Z direction. The first portion 21 of the connection component 20N has a first attachment hole 21h with which the fastening member 72 is engaged. The first attachment hole 21h is open in the Z direction. An inner circumferential surface of the first attachment hole 21h of the connection component 20N has a screw groove. The fastening member 72 that has passed through the attachment hole 13h of the terminal 13 of the electronic component 10N is engaged with the first attachment hole 21h of the first portion 21, and thus the first portion 21 is physically and electrically connected to the terminal 13 of the electronic component 10N.

### (Second Portion)

The second portion 22 of the connection component 20N is a portion connected to the bus bar 42. The second portion 22 protrudes in the horizontal direction (for example, the X direction) from end of the first portion 21 on the −Z direction side. The second portion 22 is a plate portion provided in the horizontal direction. The second portion 22 is adjacent to the bus bar 42 in the Z direction, and is connected to the bus bar 42 from the Z direction. The second portion 22 of the connection component 20N is attached from the Z direction to the fastening member 43 (for example, a screw or a bolt) protruding from the bus bar 42 in the +Z direction, and is physically and electrically connected to the bus bar 42. In the present embodiment, the second portion 22 of the connection component 20N has a second attachment hole 22h through which the fastening member 43 passes. The second attachment hole 22h is open in the Z direction. In the second portion 22, the fastening member 43 that will be described later passes through the second attachment hole 22h. A fastening element such as a nut is engaged with the tip of the fastening member 43 that has passed through the second attachment hole 22h, and thus the second portion 22 is fixed to the bus bar 42.

### (Third Portion)

The third portion 23 is a standing wall (side wall) standing in the +Z direction from both ends of the second portion 22 in the horizontal direction. The third portion 23 is a wall provided in the Z direction. The third portion 23 is connected to the first portion 21 and is also connected to the second portion 22. For example, the third portion 23 extends obliquely so as to increase in the X direction as proceeding in the −Z direction. The third portion 23 may be provided in the connection component 20M described above. On the other hand, the connection component 20N need not have the third portion 23.

### <3.5 Connection Component for External Connection>

Next, the connection component 30 for external connection will be described.

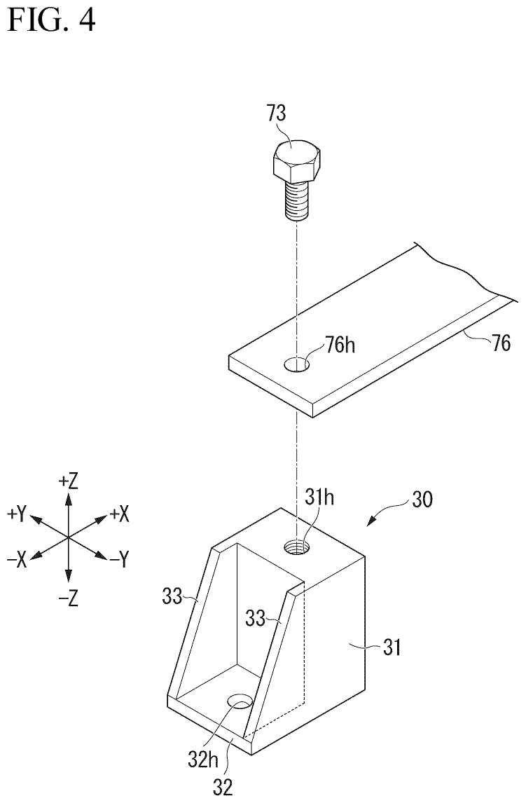

FIG. 4 is a perspective view illustrating the connection component 30 for external connection. The connection component 30 is a component that electrically connects an external connection bus bar 76 to the routing board 40. For example, the connection component 30 electrically connects the external connection bus bar 76 to the bus bar 42 included in the routing board 40. The external connection bus bar 76 is electrically connected to an external device. In the present disclosure, the “external device” is an electrical device existing outside the electrical connection unit 1. The external device is, for example, a battery unit mounted on a vehicle or an inverter for driving a motor of the vehicle, but is not limited to these examples. The connection component 30 includes, for example, a first portion 31, a second portion 32, and a third portion 33.

### (First Portion)

The first portion 31 is a portion connected to the external connection bus bar 76. The first portion 31 is a rectangular parallelepiped portion extending in the Z direction. The first portion 31 is a standing portion that stands in the Z direction with respect to the routing board 40 (for example, with respect to the bus bar 42). The first portion 31 is adjacent to the external connection bus bar 76 in the Z direction, and is connected to the external connection bus bar 76 from the Z direction. The first portion 31 has a first attachment hole 31h through which a fastening member 73 (for example, a screw or a bolt) passes. The first attachment hole 31h is open in the Z direction. An inner circumferential surface of the first attachment hole 31h has a screw groove. The fastening member 73 that has passed through the attachment hole 76h of the external connection bus bar 76 is engaged with the first attachment hole 31h of the first portion 31, and thus the first portion 31 is physically and electrically connected to the external connection bus bar 76.

### (Second Portion)

The second portion 32 is a portion connected to the bus bar 42. The second portion 32 protrudes in the horizontal direction (for example, the X direction) from the end of the first portion 31 on the −Z direction side. The second portion 32 is a plate portion provided in the horizontal direction. The second portion 32 is adjacent to the bus bar 42 in the Z direction, and is connected to the bus bar 42 from the Z direction. The second portion 32 is attached from the Z direction to the fastening member 43 (for example, a screw or a bolt) protruding from the bus bar 42 in the +Z direction, and is physically and electrically connected to the bus bar 42. In the present embodiment, the second portion 32 has a second attachment hole 32h through which the fastening member 43 passes. The second attachment hole 32h is open in the Z direction. In the second portion 32, the fastening member 43 that will be described later passes through the second attachment hole 32h. A fastening element such as a nut is engaged with the tip of the fastening member 43 that has passed through the second attachment hole 32h, and thus the second portion 32 is fixed to the bus bar 42.

### (Third Portion)

The third portion 33 is a standing wall (side wall) standing in the +Z direction from both ends of the second portion 32 in the horizontal direction. The third portion 33 is a wall provided in the Z direction. The third portion 33 is connected to the first portion 31 and is also connected to the second portion 32. For example, in FIG. 4, the third portion 33 extends in an inclined manner to increase in size in the X direction (or the Y direction) as proceeding in the −Z direction. The connection component 30 need not include the third portion 33.

### <3.6 Routing Board>

Next, the routing board 40 will be described.

The routing board 40 is a member that forms at least part of an energization path between the plurality of electronic components 10 and/or at least part of an energization path between the electronic component 10 and an external device. In the present disclosure, the “routing board” indicates a board-type routing structure. The “board type” indicates a plate shape along one plane when viewed as a whole regardless of a fine shape. In the present disclosure, the term “plate shape” or “planar” is not limited to the case of being completely flat, and may include a case where a fixing structure, a rib, or the like protruding in the Z direction is partially present, a case where an uneven shape following the thickness of the bus bar is present on the surface, and the like. In the present embodiment, the routing board 40 has a plate shape formed in the X direction and the Y direction.

The routing board 40 has a rectangular shape formed in the X direction when viewed from the Z direction. The routing board 40 has a first end 40e1, a second end 40e2, a third end 40e3, and a fourth end 40e4. The first end 40e1 and the second end 40e2 are a pair of ends of the routing board 40 in the longitudinal direction, and are separated in the X direction. The third end portion 40e3 and the fourth end portion 40e4 are a pair of end portions of the routing board 40 in the lateral direction, and are separated in the Y direction.

The routing board 40 includes, for example, a base portion 41, a plurality of bus bars 42, and a plurality of fastening members 43. The plurality of bus bars 42 include at least one or more first bus bars 42a and at least one or more second bus bars 42b. A constitution ratio of the first bus bar 42a and the second bus bar 42b in the plurality of bus bars 42 is changed as appropriate according to a three-dimensional routing structure. For example, in the present embodiment, the routing board 40 includes two bus bars 42. The two bus bars 42 include the first bus bar 42a and the second bus bar 42b.

The first bus bar 42a is a first-type bus bar 42, and is used for routing in a three-dimensional way. The second bus bar 42b is a second-type bus bar 42, and is used for planar routing. The first bus bar 42a and the base portion 41 are integrated through insert molding. For example, the routing board 40 is formed as a single member by insert-molding the first bus bar 42a with the base portion 41 after the fastening member 43 is fixed to the first bus bar 42a. That is, the first bus bar 42a is integrated with the base portion 41 without using a fastening member such as a screw or a bolt.

The second bus bar 42b may be placed after a groove is separately formed in the base portion 41. Alternatively, the second bus bar 42b and the base portion 41 may be integrated through insert molding. When the second bus bar 42b is integrated with the base portion 41, handling at the time of assembly is facilitated.

Hereinafter, the base portion 41, the bus bars 42 (the first bus bar 42a and the second bus bar 42b), and the fastening member 43 will be described.

### (Base Portion)

The base portion 41 is a holding member that integrally holds the plurality of bus bars 42 three-dimensionally intersecting each other with a space therebetween. The base portion 41 is made of, for example, a synthetic resin and has an insulating property. The base portion 41 electrically insulates the plurality of bus bars 42 from each other. The base portion 41 is an example of a “base member”. The base portion 41 may be referred to as an “insulating base material”. The base portion 41 includes, for example, a flat surface portion 51.

The flat surface portion 51 is a portion formed in a plate shape in the base portion 41. The flat surface portion 51 has a plate shape formed in the horizontal direction. The flat surface portion 51 forms a main portion of the base portion 41. The flat surface portion 51 forms a base (insulating base portion) of the base portion 41. In the present embodiment, the flat surface portion 51 extends over the entire width of the base portion 41 in the X direction and over the entire width of the base portion 41 in the Y direction.

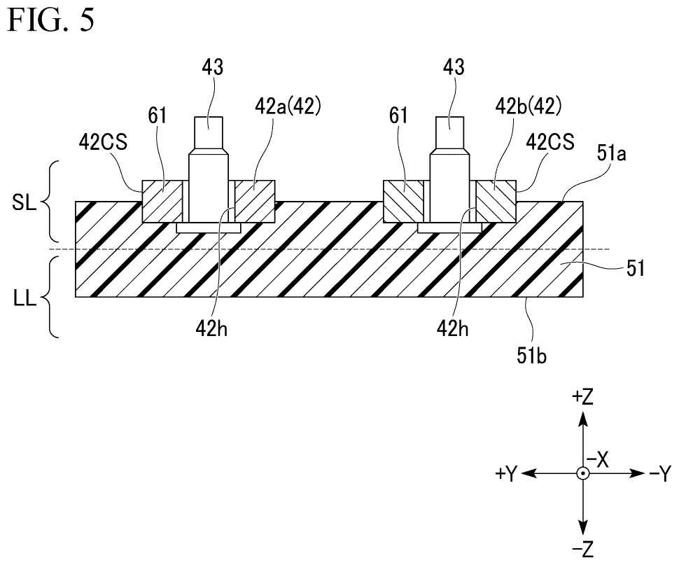

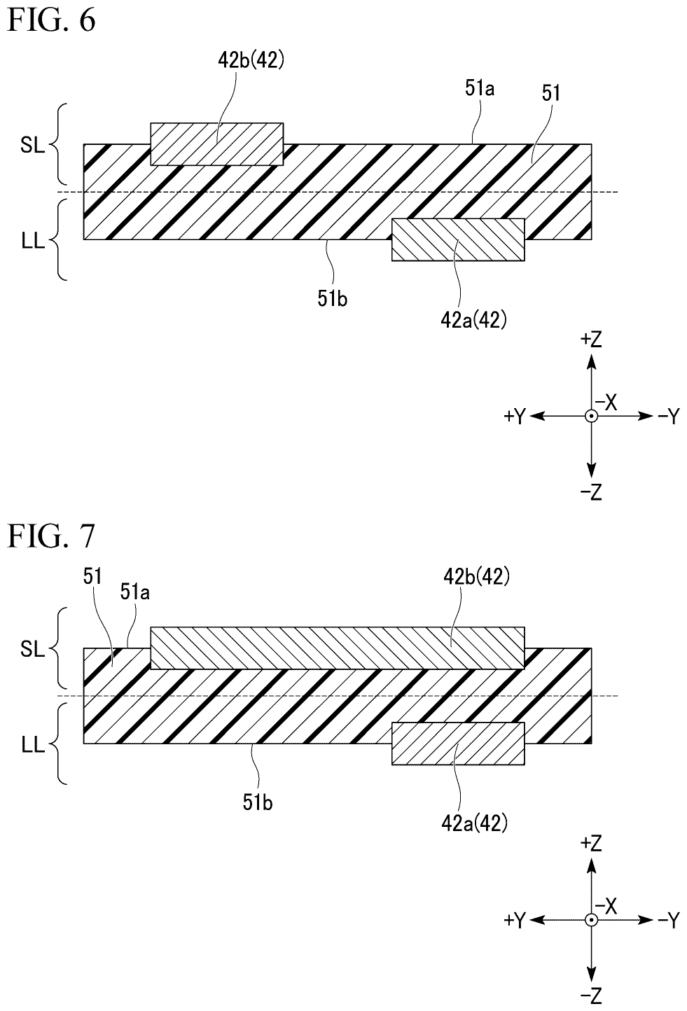

As illustrated in FIGS. 5 to 8, the flat surface portion 51 has a first surface 51a and a second surface 51b. The first surface 51a is a surface directed in the +Z direction. The first surface 51a is a flat surface provided in the horizontal direction. The first surface 51a faces at least one or more electronic components 10. The second surface 51b is located on the side opposite to the first surface 51a. The second surface 51b is a surface directed in the −Z direction. The second surface 51b is a flat surface provided in the horizontal direction. A thickness direction (plate thickness direction) of the flat surface portion 51 is the Z direction.

The flat surface portion 51 holds one bus bar 42 among the plurality of bus bars 42 to be separated from the other bus bar 42, for example.

The flat surface portion 51 holds part of a routing portion that will be described later inside the base portion 41. In this case, a routing structure in a three-dimensional way (hereinafter refers to as a “three-dimensional routing structure”) including the plurality of bus bars 42 is maintained. Among the plurality of bus bars 42 included in the three-dimensional routing structure, a specific bus bar 42 three-dimensionally intersects the other bus bars 42. For example, in the present embodiment, the specific bus bar 42 is the first bus bar 42a.

For example, the flat surface portion 51 may have a protrusion or a through-hole corresponding to the attachment hole 14h. The electronic component 10M is integrated with the routing board 40 by using the protrusion or the through-hole. In a case where the flat surface portion 51 has the protrusion, the electronic component 10M may be fixed through thermal caulking. By fixing the electronic component 10M through thermal caulking, the number of components related to fixing of the electronic component 10M can be reduced. In a case where the flat surface portion 51 has the above through-hole, the electronic component 10M may be fixed through mechanical joining using a fastening element such as a screw or a bolt.

### (Bus Bar)

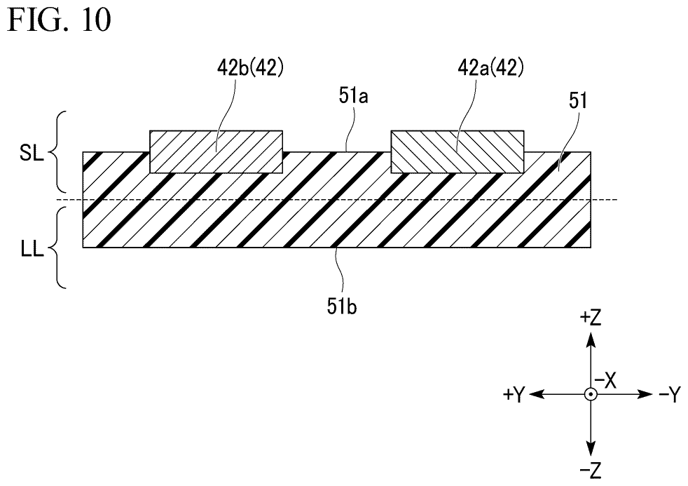

The bus bar 42 is a routing member (electrical connection member) included in the routing board 40. The bus bar 42 includes, for example, a first connection portion 61, a second connection portion 62, and a routing portion 63. The bus bar 42 is, for example, a routing member for electrically connecting the plurality of electronic components 10. Alternatively, the bus bar 42 may be a routing member for connecting the electronic component 10 to an external device. The bus bar 42 is made of a metal (for example, copper or a copper alloy) and has conductivity. The thickness of the bus bar 42 is 1 mm or more (for example, 3 mm or more) to 20 mm. As described above, in the present embodiment, the routing board 40 includes, for example, the first bus bar 42a and the second bus bar 42b as the plurality of bus bars 42. The first bus bar 42a and the second bus bar 42b are disposed to three-dimensionally intersect each other with a space therebetween. The first bus bar 42a and the second bus bar 42b include portions disposed on the same plane (see FIG. 10). For example, the first bus bar 42a and the second bus bar 42b are constituted such that the first connection portions 61 included in the bus bars 42a and 42b are disposed on the same plane. In the present embodiment, for example, the first bus bar 42a and the second bus bar 42b are constituted such that the second connection portions 62 included in the bus bars 42a and 42b are disposed on the same plane. However, the second connection portions 62 need not exist on the same plane. A modification example related to disposition of the second connection portion 62 will be described later.

At least part of each bus bar 42 has a plate shape formed in the horizontal direction. At least part of each bus bar 42 extends along the flat surface portion 51. That is, at least part of each bus bar 42 extends in a plate shape along the first surface 51a of the flat surface portion 51. At least part of each bus bar 42 extends in the horizontal direction. In the present embodiment, an extending portion 631 of the first bus bar 42a extends in a plate shape along the flat surface portion 51. In this case, the extending portion 631 of the first routing portion 63a is held by a lower part LL of the base portion 41. The lower part LL is an example of a second part.

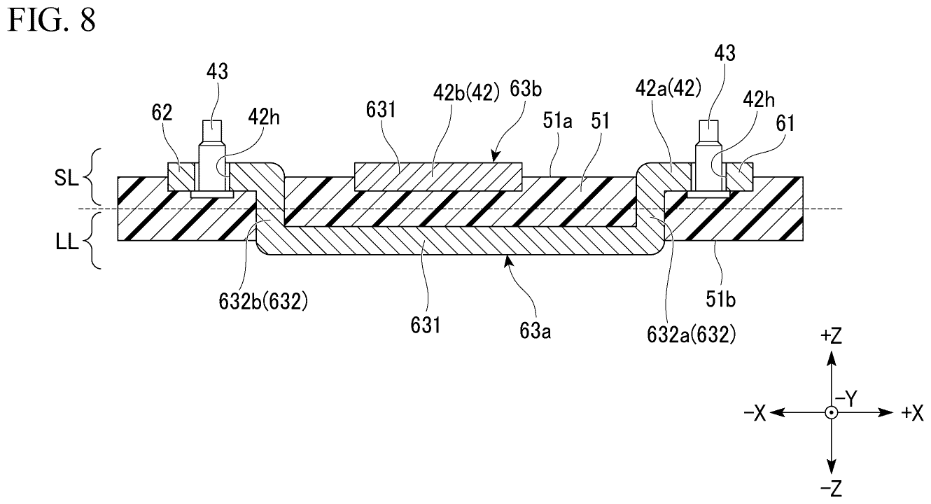

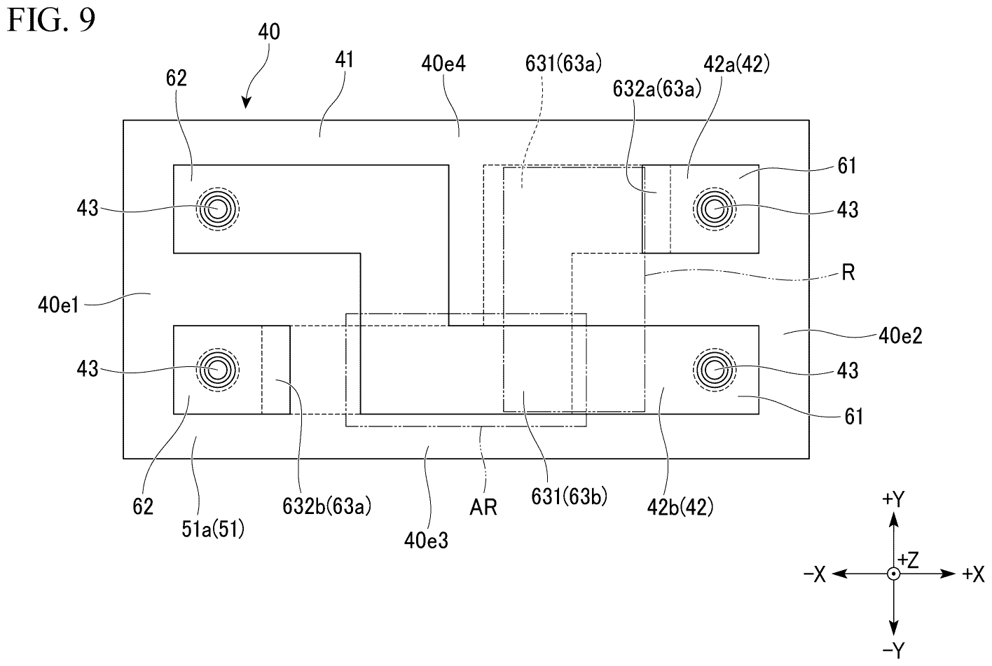

As illustrated in FIG. 9, when viewed from the thickness direction (Z direction), part of the extending portion 631 in the first routing portion 63a passes through a region overlapping the second bus bar 42b. For example, in the present embodiment, when viewed from the thickness direction (Z direction), part of the extending portion 631 in the first routing portion 63a passes through a region AR overlapping the extending portion 631 in the second routing portion 63b. As illustrated in FIG. 8, the extending portion 631 of the first routing portion 63a is exposed from the base member (base portion 41) in the lower part LL. The first bus bar 42a in the present embodiment is a member that forms energization paths in the horizontal direction and the vertical direction. A bent portion 632 that will be described later is used to form an energization path in the vertical direction.

The second bus bar 42b has a plate shape formed in the horizontal direction over the entire second bus bar 42b. In the second bus bar 42b, at least part of a second routing portion 63b that will be described later is held by an upper part SL of the base portion 41 and extends along the flat surface portion 51. The upper part SL is an example of a first part. In the present embodiment, the extending portion 631 of the second bus bar 42b extends in a plate shape along the flat surface portion 51. In this case, the extending portion 631 in the second routing portion 63b is held by the upper part SL of the base portion 41. The second bus bar 42b in the present embodiment is a member that forms an energization path in the horizontal direction.

The first connection portion 61 is a portion in contact with one connection component 20 (hereinafter referred to as a “first connection component 20”). The first connection component 20 is a connection component that connects one electronic component 10 (hereinafter referred to as a “first electronic component 10”) to the bus bar 42. The first connection portion 61 is held by the upper part SL of the base portion 41 and extends along the insulating base portion. The first connection portion 61 is a portion of the bus bar 42 overlapping the first connection component 20 when viewed from the Z direction. The first connection portion 61 is adjacent to the first connection component 20 in the Z direction, and is connected to the first connection component 20 from the Z direction.

The second connection portion 62 is a portion in contact with another connection component 20 (hereinafter referred to as a “second connection component 20”). The second connection component 20 is a connection component that connects another electronic component 10 (hereinafter referred to as a “second electronic component 10”) included in the plurality of electronic components 10 to the bus bar 42. For example, the second connection portion 62 in the present embodiment is held by the upper part SL of the base portion 41 and extends along the insulating base portion. The second connection portion 62 is a portion of the bus bar 42 overlapping the second connection component 20 when viewed from the Z direction. The second connection portion 62 is adjacent to the second connection component 20 in the Z direction, and is connected to the second connection component 20 from the Z direction.

Note that the first connection portion 61 and/or the second connection portion 62 may be a portion in contact with another connection component 30 (hereinafter referred to as a “second connection component 30”) instead of the above example. The connection component 30 is a connection component for connecting an external device to the bus bar 42. In this case, the first connection portion 61 (second connection portion 62) is a portion of the bus bar 42 overlapping the second connection component 30 when viewed from the Z direction. The first connection portion 61 (second connection portion 62) is adjacent to the second connection component 30 in the Z direction, and is connected to the second connection component 30 from the Z direction.

In addition, the first connection portion 61 may be a portion in contact with a coupling bus bar for connection to another subunit SU instead of the connection components 20 and 30. In this case, the first connection portion 61 is a portion of the bus bar 42 that overlaps a coupling bus bar when viewed from the Z direction. The first connection portion 61 is adjacent to the coupling bus bar in the Z direction, and is connected to the coupling bus bar from the Z direction. The coupling bus bar is an example of a third bus bar.

In addition, the second connection portion 62 may be a portion in contact with a coupling bus bar for connection to another subunit SU instead of the connection components 20 and 30. In this case, the second connection portion 62 is a portion of the bus bar 42 that overlaps the coupling bus bar when viewed from the Z direction. The second connection portion 62 is adjacent to the coupling bus bar in the Z direction, and is connected to the coupling bus bar from the Z direction.

The routing portion 63 is provided between the first connection portion 61 and the second connection portion 62. The routing portion 63 extends over the first connection portion 61 and the second connection portion 62. The routing portion 63 connects the first connection portion 61 to the second connection portion 62.

The first bus bar 42a includes a first routing portion 63a serving as the first-type routing portion 63. The first routing portion 63a in the first bus bar 42a is routed from the first connection portion 61 in the upper part SL of the insulating base portion to the lower part LL. The first routing portion 63a includes an extending portion 631 and at least one or more bent portions 632. The extending portion 631 extends in the X direction or the Y direction and forms an energization path in the horizontal direction. The bent portion 632 is a member that forms an energization path crossing the extending direction of the extending portion 631. The bent portion 632 forms an energization path in the Z direction. For example, in the present embodiment, the first bus bar 42a includes a first bent portion 632a and a second bent portion 632b as the bent portions 632. The first bent portion 632a is bent from the first connection portion 61 toward the extending portion 631 to electrically connect the first connection portion 61 to the extending portion 631. The second bent portion 632b is bent from the extending portion 631 toward the second connection portion 62 to electrically connect the extending portion 631 to the second connection portion 62. In the first bus bar 42a, the first routing portion 63a extends over the first connection portion 61 and the second connection portion 62. In the first bus bar 42a, the first connection portion 61, the first routing portion 63a, and the second connection portion 62 (the first connection portion 61, the first bent portion 632a, the extending portion 631, the second bent portion 632b, and the second connection portion 62) are electrically connected in this order.

The second bus bar 42b includes a second routing portion 63b as the second-type routing portion 63. The second routing portion 63b includes an extending portion 631. The second routing portion 63b of the second bus bar 42b is routed in the X direction or the Y direction from the first connection portion 61. In the second bus bar 42b, the first connection portion 61, the second routing portion 63b (extending portion 631), and the second connection portion 62 are electrically connected in this order.

In the present embodiment, the routing portions 63 (the first routing portion 63a and the second routing portion 63b) of some of the bus bars 42 are held by the base portion 41, and thus extend over both sides of the region R through the region R overlapping the electronic component 10 when viewed from the Z direction. For example, at least part of the routing portion 63 extends linearly in the X direction. At least part of the routing portion 63 extends over the +X direction side and the −X direction side of the region R through the region R overlapping the electronic component 10 when viewed from the Z direction. For example, the extending portion 631 extends over the +X direction side and the −X direction side of the region R through the region R overlapping the electronic component 10 when viewed from the Z direction.

For example, as illustrated in FIGS. 5 and 8, in the present embodiment, at least part of the first connection portion 61 of the bus bar 42 is exposed to the outside of the base portion 41 on the upper surface side (the first surface 51a side of the flat surface portion 51). For example, the first connection portion 61 of the bus bar 42 is exposed from the base portion 41 at least in part of the region R overlapping the electronic component 10. That is, the first connection portion 61 protrudes from the first surface 51a in the first direction (Z direction). In other words, the first surface 51a is recessed in the Z direction with respect to the first connection portion 61. In this case, part of a side peripheral surface 42CS of the bus bar 42 is exposed from the base portion 41. The side peripheral surface 42CS faces in a direction intersecting the first direction. According to such a constitution, the first surface 51a hardly pushes up the connection components 20 and 30 or the coupling bus bar in the +Z direction. Since the contact area at the contact portion between the bus bar 42 and the connection components 20 and 30 or the coupling bus bar is easily secured, the electrical connection between the bus bar 42 and the connection components 20 and 30 or the coupling bus bar is easily ensured.

Some routing examples of the bus bar 42 will be described below.

### First Routing Example

First, a routing example related to the first bus bar 42a will be described. The first bus bar 42a includes a first connection portion 61, a second connection portion 62, and a first routing portion 63a. As illustrated in FIG. 1 again, the first connection portion 61 is located on the +X direction side with respect to the electronic component 10 (electronic component 10M). The first connection portion 61 is electrically connected to the terminal 13B of the electronic component 10 via the connection component 20B which is the first connection component 20 (connection component 20M). The second connection portion 62 is located on the −X direction side with respect to the electronic component 10 (electronic component 10M). The second connection portion 62 is electrically connected to another electronic component 10 via the connection component 20, electrically connected to an external device via the connection component 30, or electrically connected to another subunit SU via a coupling bus bar. When the electronic component 10 electrically connected to the first connection portion 61 is the electronic component 10N, the first connection portion 61 is located on the −X direction side with respect to the electronic component 10N. This electronic component 10N is electrically connected to another routing board 40.

The routing portion 63 (first routing portion 63a) extends over both sides of the region R through the region R overlapping the electronic component 10 when viewed from the Z direction. Since the first routing portion 63a is routed from the upper part (first part) to the lower part (second part) of the insulating base portion, the extending portion 631 of the first routing portion 63a is exposed from the second surface 51b. For example, part of the first routing portion 63a extends linearly in the X direction. In the present embodiment, the extending portion 631 of the first routing portion 63a extends linearly in the X direction. The extending portion 631 of the first routing portion 63a extends the +X direction side and the −X direction side of the region R through the region R overlapping the electronic component 10 (electronic component 10M) when viewed from the Z direction.

### Second Routing Example

Next, a routing example related to the second bus bar 42b will be described. The second bus bar 42b includes a first connection portion 61, a second connection portion 62, and a second routing portion 63b. As illustrated in FIG. 1, the first connection portion 61 is electrically connected to the terminal 13A of the electronic component 10 via a connection component 20A which is the first connection component 20 (connection component 20M). The second connection portion 62 is electrically connected to another electronic component 10 via the connection component 20, electrically connected to an external device via the connection component 30, or electrically connected to another subunit SU via a coupling bus bar.

The bus bar 42b has the routing portion 63 (second routing portion 63b) extending over both sides of the region R through the region R overlapping the electronic component 10 (electronic component 10M) when viewed from the Z direction. The extending portions 631 of the first routing portion 63a are arranged in the −Z direction with respect to the second routing portion 63b.

### (Fastening Member)

Next, referring to FIG. 1 again, the fastening member 43 will be described. The fastening member 43 is a component for fixing the bus bar 42 and a connection target component (the connection component 20, the connection component 30, or a coupling bus bar) of the bus bar 42. The fastening member 43 is, for example, a caulking bolt fixed to the bus bar 42. The fastening member 43 is an example of a “fastening portion”.

In the present embodiment, each of the first connection portion 61 and the second connection portion 62 of the bus bar 42 has a through-hole 42h. The through-hole 42h penetrates the bus bar 42 in the Z direction. The fastening member 43 is, for example, a bolt having a shaft and a head. A peripheral surface of the shaft has a screw groove. The head has a diameter larger than that of the shaft. The head of the fastening member 43 is caulked and fixed to the bus bar 42 in a state in which the shaft passes through the through-hole 42h of the bus bar 42. With this fixing, the fastening member 43 is electrically and physically connected to the bus bar 42 in a state in which the shaft protrudes in the +Z direction from the through-hole 42h of the bus bar 42. The fastening member 43 is not limited to caulking fixation, and may be fixed to the bus bar 42 through welding or other methods.

In the present embodiment, the connection component 20 is attached to the fastening member 43 from the Z direction in a state of being previously fixed to the electronic component 10 via the fastening member 72 or the fastening member 71. For example, the connection component 20 allows the shaft of the fastening member 43 to be inserted into the second attachment hole 22h of the second portion 22. A fastening element such as a nut is engaged with the shaft of the fastening member 43 protruding from the second attachment hole 22h of the second portion 22 of the connection component 20. This engagement fixes the second portion 22 of the connection component 20 to the fastening member 43.

### 4. Advantages

As Comparative Example A, an electrical connection unit in which a bus bar is disposed in a standing posture with respect to a lower wall of a housing will be considered. In such a constitution of the comparative example, for example, since a cross-sectional area of a bus bar is determined in order to function as a routing member, it may be difficult to reduce a width (height) of the standing bus bar. When the electrical connection unit takes a complicated routing path, the width of the standing bus bar becomes a bottleneck, and it may be difficult to reduce the height of the electrical connection unit.

On the other hand, in the present embodiment, the routing board 40 constituting the electrical connection unit 1 includes a base member (base portion 41) having an insulating base portion, a first bus bar 42a held by the insulating base portion and including the routing portion 63 (first routing portion 63a) routed from the first part (upper part SL) to the second part (lower part LL) of the insulating base portion, and a second bus bar 42b held by the first part (upper part SL) of the insulating base portion. When viewed from a thickness direction (Z direction) of the insulating base portion, part of the first bus bar 42a passes through a region overlapping the second bus bar 42b, at least part of the first bus bar 42a extends in a plate shape along the insulating base portion, and at least part of the second bus bar 42b extends in a plate shape along the insulating base portion. According to such a constitution, since a routing path (bus bar 42) is incorporated in the base member, and the first bus bar 42a can have a three-dimensional routing structure with respect to the second bus bar 42b. In the three-dimensional routing structure including the plurality of bus bars 42, the routing path of the first bus bar 42a can take the shortest path. In this case, since at least part of the routing path is formed on a plane, the width of the bus bar is less likely to become a bottleneck compared with the above structure of Comparative Example A, and the height of the electrical connection unit 1 can be easily reduced.

In the present embodiment, the routing portion 63 (first routing portion 63a) includes the extending portion 631, the extending portion 631 is held by the second part (lower part LL) of the insulating base portion, and part of the extending portion 631 extends through a region overlapping the second bus bar 42b when viewed from the thickness direction (Z direction). According to such a constitution, since a routing path (bus bar 42) is incorporated in the base member, and the first bus bar 42a can have a three-dimensional routing structure with respect to the second bus bar 42b. In the three-dimensional routing structure including the plurality of bus bars 42, the routing path of the first bus bar 42a can take the shortest path. In this case, since at least part of the routing path is formed on a plane, the width of the bus bar is less likely to become a bottleneck compared with the above structure of Comparative Example A, and the height of the electrical connection unit 1 can be easily reduced.

In the present embodiment, the extending portion 631 of the first routing portion 63a is exposed from the base member (base portion 41) in the second part (lower part LL). According to such a constitution, at least part of portions of the bus bar 42 other than the first connection portion 61 and the second connection portion 62 connected to other components is exposed to the outside of the base portion 41 and functions as a surface that releases heat. In this case, the heat dissipation property of the electrical connection unit 1 can be improved.

In the present embodiment, the first bus bar 42a includes the first connection portion 61 electrically connected to an electronic component, a device, or a third bus bar, and the first connection portion 61 is held by the first part (upper part SL) and extends along the insulating base portion. According to such a constitution, single use of the routing board 40 or connection to another subunit SU can be selected as appropriate.

In the present embodiment, the first bus bar 42a includes the second connection portion 62 electrically connected to an electronic component, a device, or a third bus bar, and the second connection portion 62 is held by the first part (upper part SL) and extends along the insulating base portion. According to such a constitution, single use of the routing board 40 or connection to another subunit SU can be selected as appropriate.

In the present embodiment, the first routing portion 63a includes at least one or more bent portions 632, and in the first bus bar 42a, the first routing portion 63a extends over the first connection portion 61 and the second connection portion 62. According to such a constitution, the degree of freedom in routing the first bus bar 42a in a three-dimensional routing structure can be improved.

In the present embodiment, the first bus bar 42a is integrated with the base member (base portion 41). According to such a constitution, the first bus bar 42a is integrated by the base portion 41. This integration enables the first bus bar 42a to be easily routed three-dimensionally in a better path (for example, a path with a shorter distance) without being disturbed by the presence of the electronic component 10.

In addition, since the first bus bar 42a and the base member (base portion 41) can be integrally handled, workability related to attachment of the bus bar 42 can be improved. The integration can improve the assemblability of the electrical connection unit 1.

In the present embodiment, the electrical connection unit 1 includes the above routing board 40 and the electronic component 10 (electronic component 10M) electrically connected to the first bus bar 42a. According to such a constitution, at least part of the routing path is formed on a plane. Compared with the above structure of Comparative Example A, the width of the bus bar is less likely to be a bottleneck, and the height of the electrical connection unit 1 can be easily reduced.

### First Modification Example

In the above disclosure, the second connection portion 62 of the first bus bar 42a is held by the first part (upper part SL) of the base portion 41 and extends along the insulating base portion. On the other hand, as a modification example, the second connection portion 62 of the first bus bar 42a may be held by the second part (lower part LL) of the base portion 41 and extend along the insulating base portion. According to such a constitution, the degree of freedom of the three-dimensional routing structure using the first bus bar 42a is further improved.

### Second Modification Example

In the above disclosure, the insulating base material insulates the first bus bar 42a from the second bus bar 42b. By using such a function, as a modification example, in the routing board 40, each bus bar may function as either a positive electrode line or a negative electrode line. For example, the first bus bar 42a is a bus bar included in either the positive electrode line or the negative electrode line of the electrical connection unit 1. For example, the second bus bar 42b is a bus bar included in the other of the positive electrode line and the negative electrode line of the electrical connection unit 1.

### Third Modification Example

The connection component 30 in the above disclosure electrically connects the external connection bus bar 76 to the bus bar 42 included in the routing board 40. On the other hand, as a modification example, the external connection bus bar 76 may be directly connected to the first connection portion 61 and/or the second connection portion 62.

### Fourth Modification Example

The first routing portion 63a of the first bus bar 42a in the above disclosure has at least one or more bent portions 632. On the other hand, as a modification example, instead of forming an energization path in the vertical direction using the bent portion 632, the energization path in the vertical direction using the conductive member 44 may be formed.

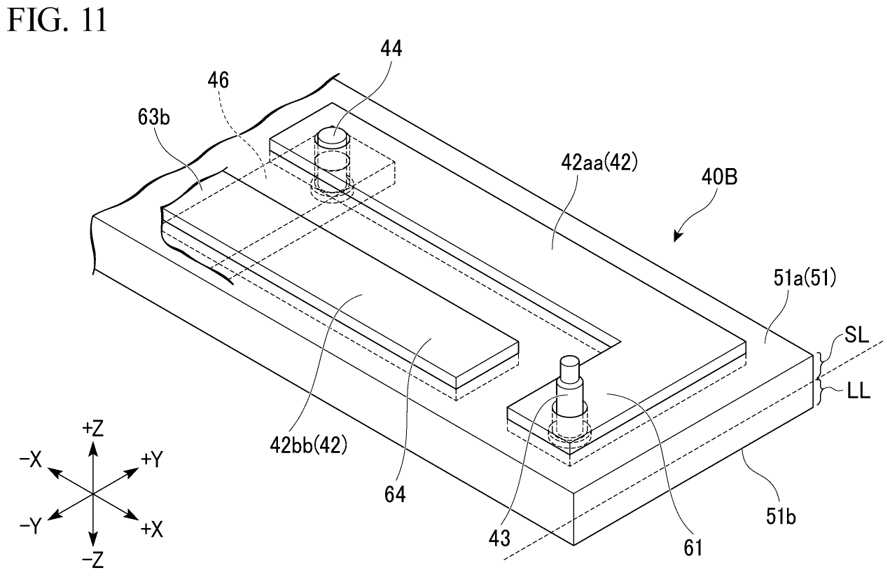

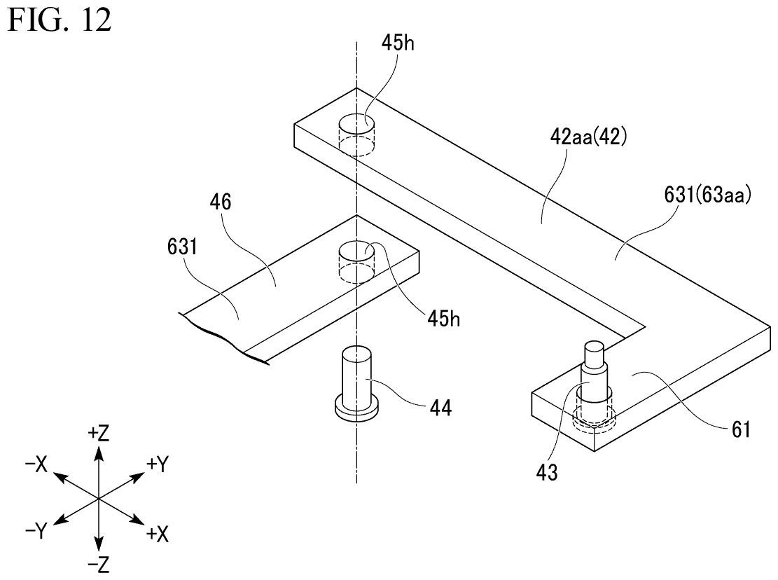

As the present modification example, a routing board 40B is illustrated in FIG. 11. The routing board 40B includes, for example, a base portion 41, a plurality of bus bars 42, and a plurality of fastening members 43. In the present modification example, the routing board 40B includes two bus bars 42. The two bus bars 42 include a fourth bus bar 42aa and a fifth bus bar 42bb. The fourth bus bar 42aa is a member that forms energization paths in the horizontal direction and the vertical direction, similarly to the first bus bar 42a. The fourth bus bar 42aa includes a first connection portion 61, a third routing portion 63aa, and a second connection portion 62 (not illustrated). The third routing portion 63aa includes an extending portion 631, a conductive member 44, and a plate portion 46. The conductive member 44 is located to be passed between the first part (upper part SL) and the second part (lower part LL) of the insulating base portion.

The plate portion 46 includes an extending portion 631. The plate portion 46 has a through-hole 45h with which the conductive member 44 can be engaged. The third routing portion 63aa has the through-hole 45h with which the conductive member 44 can be engaged. Each through-hole 45h is formed in part of the extending portion 631 of the third routing portion 63aa and in part of the extending portion 631 of the plate portion 46. When the third routing portion 63aa and the plate portion 46 are electrically connected via the conductive member 44, the fourth bus bar 42aa forms energization paths in the horizontal direction and the vertical direction.

Similarly to the second bus bar 42b, the fifth bus bar 42bb is a member forming an energization path in the horizontal direction. The fifth bus bar 42bb includes a first connection portion 61 (not illustrated), a second routing portion 63b, a second connection portion 62 (not illustrated), and an extension 64. The extension 64 has a plate shape formed in the horizontal direction. The extension 64 is held by the upper part SL of the base portion 41 and extends along the flat surface portion 51. The extension 64 is a portion where the bus bar 42 extends for the purpose of increasing a heat dissipation area and/or increasing a heat capacity for heat storage (heat absorption). The extension 64 is a portion that is not used for electrical connection.

In the present modification example, for the purpose of improving a heat dissipation property, the plate portion 46 of the fourth bus bar 42aa may be exposed from the base portion 41 in the second part (lower part LL) of the insulating base portion. In the present modification example, the plurality of bus bars may include a first bus bar 42a, a second bus bar 42b, a fourth bus bar 42aa, and a fifth bus bar 42bb.

### Fifth Modification Example

One or more bus bars 42 may have an extension 64 in addition to the first connection portion 61, the second connection portion 62, and the extending portion 631.

### Sixth Modification Example

A connection between the electronic component 10 and the bus bar 42 is not limited to the connection using the connection component 20. The electronic component 10 may be directly connected to the bus bar 42 by using a fastening member (for example, a bolt or a screw), welding, or the like. For example, the terminal 13 of the electronic component 10 and bus bar 42 may be brought into direct contact with each other through welding or the like.

Several embodiments and modification examples have been described above. However, the embodiment and the modification examples are not limited to the examples described above. For example, a plurality of embodiments may be implemented in combination with each other. The above-described embodiments can be implemented in various other forms, and various additions, omissions, substitutions, and changes can be made without departing from the concept of the present disclosure.

### INDUSTRIAL APPLICABILITY

According to the present disclosure, the height of the electrical connection unit can be reduced.

### REFERENCE SIGNS LIST

1 Electrical connection unit
10 Electronic component
11 Case
11a Insulating rib
12 Component body
13 Terminal
13A Terminal
13B Terminal
13h Attachment hole
14 Attachment portion
14h Attachment hole
10 First electronic component
10M Electronic component
10N Electronic component
20 Connection component
21 First portion
21h First attachment hole
22 Second portion
22h Second attachment hole
23 Third portion
20 First connection component
20 Second connection component
20A Connection component
20B Connection component
20M Connection component
20N Connection component
30 Connection component
31 First portion
31h First attachment hole
32 Second portion
32h Second attachment hole
33 Third portion
30 Second connection component
40 Routing board
40e1 First end
40e2 Second end
40e3 Third end
40e4 Fourth end
41 Base portion
42 Bus bar
40B Routing board
42a First bus bar
42aa Fourth bus bar
42b Second bus bar
42bb Fifth bus bar
42CS Side peripheral surface
42h Through-hole
43 Fastening member
44 Conductive member
45h Through-hole
46 Plate portion
51 Flat surface portion
51a First surface
51b Second surface
61 First connection portion
62 Second connection portion
63a First routing portion
63aa Third routing portion
63b Second routing portion
64 Extension
71 Fastening member
72 Fastening member
73 Fastening member
76 External connection bus bar
76h Attachment hole
631 Extending portion
632 Bent portion
632a First bent portion
632b Second bent portion
AR Region
R Region
LL Lower part
SL Upper part
MU Main body
SU Subunit

What is claimed is:

1. A routing board comprising:
a base member that has an insulating base portion;
a first bus bar that is held by the insulating base portion and includes a routing portion routed from a first part to a second part of the insulating base portion; and
a second bus bar that is held by the first part,
wherein a part of the first bus bar passes through a region overlapping the second bus bar when viewed from a thickness direction of the insulating base portion,
at least a part of the first bus bar extends in a plate shape along the insulating base portion, and
at least a part of the second bus bar extends in a plate shape along the insulating base portion.

2. The routing board according to claim 1, wherein
the routing portion includes an extending portion,
the extending portion is held by the second part, and
a part of the extending portion extends through a region overlapping the second bus bar when viewed from the thickness direction.

3. The routing board according to claim 2, wherein
the extending portion is exposed from the base member in the second part.

4. The routing board according to claim 2, wherein
the routing portion further includes a conductive member electrically connected to the extending portion, and
the conductive member is located to be passed between the first part and the second part.

5. The routing board according to claim 1, wherein
the first bus bar includes a first connection portion electrically connected to an electronic component, a device, or a third bus bar, and
the first connection portion is held by the first part and extends along the insulating base portion.

6. The routing board according to claim 5, wherein
the first bus bar includes a second connection portion electrically connected to an electronic component, a device, or a third bus bar, and
the second connection portion is held by the first part and extends along the insulating base portion.

7. The routing board according to claim 6, wherein
the routing portion includes at least one or more bent portions, and
in the first bus bar, the routing portion extends over the first connection portion and the second connection portion.

8. The routing board according to claim 1, wherein
the first bus bar is integrated with the base member.

9. The routing board according to claim 1, wherein
the first bus bar is a bus bar included in one of a positive electrode line and a negative electrode line,
the second bus bar is a bus bar included in the other of the positive electrode line and the negative electrode line, and
the insulating base portion insulates the first bus bar from the second bus bar.

10. An electrical connection unit comprising:
the routing board according to claim 1; and
an electronic component electrically connected to the first bus bar.
